(19) United States
(12) Patent Application Publication
(10) Pub. No.: US 2003/0048694 A1
(43) Pub. Date: Mar. 13, 2003

(54) Material mixing device and method

(75) Inventors: Terry A. Horner, Allentown, NJ (US); Jason Henning, Plainsboro, NJ (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(73) Assignee: TAH Industries Inc.

(21) Appl. No.: 09/949,647

(22) Filed: Sep. 12, 2001

(51) Int. Cl. B01F 5/06

(52) U.S. Cl. 366/337

(57) ABSTRACT

A static mixer for mixing at least two materials wherein the mixer includes a conduit having interior walls and a central, longitudinal axis along which materials flow. The mixer has a number of baffles arranged inside the conduit and each baffle has at least two, planar webs that intersect one another and extend parallel to the flow direction wherein one web forms a rear fin extending in the material flow direction. In addition, the mixer has at least two, forward angled surfaces and at least two, rear angled surfaces that are connected by the two planar webs.

### FIELD OF THE INVENTION

The present invention relates generally to a material mixing device and method. More particularly, the present invention relates to a device and method for mixing materials such as, e.g., high viscosity liquids.

### BACKGROUND OF THE INVENTION

Various methods, machines and devices have been utilized for mixing liquids, liquid suspensions and fluids of high or differing viscosity. Most are based upon the use of a mechanically driven agitator or stirrer operating in the material to be mixed, whereby shear will promote the thorough and homogeneous intermixing of the liquids. Methods utilizing a normal rotational shear mixing process, particularly when applied to high viscosity liquids, are sometimes inefficient and non-desirable. In such cases, a large quantity of power is required to drive the agitating or mixing devices and much of the power is unavoidably converted into heat. In addition, the creation of turbulence, which is typical of a normal rotational mixing process, is neither desirable nor practicable in the mixing of materials of high or differing viscosities. The energy transformed into heat usually contributes little, if anything, to the mixing process. In many cases, the heat must be removed to avoid overheating of the mixture and such heat is almost always wasted, especially when conventional cooling means are used to absorb it.

Often, apparatuses employed in the manipulation of viscous materials are physically very large and costly to maintain and operate. Frequently, the characteristics of highly viscous materials are such that in order to promote thorough and homogenous intermixing, high rates of shear must be utilized, requiring the use of close mechanical clearances. Thus, viscous materials are oftentimes mixed on rolls, mills and/or rotary pumps. Alternatively, viscous fluids and mixtures have been mixed by forcing them to flow through passageways designed to cause turbulence in the flowing stream. The aforementioned passageways produce turbulence by a displacement of the stream elements as they are separated and recombined during the flow; however, the fluids tend to stay in a laminar flow state.

It has been found that it is beneficial to mix the fluids while they remain in a laminar flow state. This is accomplished by “static mixers.” Instead of causing random turbulent flow to disperse the fluid, static mixers cause a successive geometric layering effect. In this way, the number of layers increases while the thickness of each layer decreases as the fluids are pushed through the mixer. At the outlet of the mixer, the layers are thin enough such that the fluid components will diffuse through each other's layers, resulting in a fully homogeneous mix. This mix method is largely independent of fluid speed, and therefore requires relatively little energy input to drive the mixing. It's a smooth, simple, organized and relatively effortless method for producing a mix.

Despite their advantages, static mixers present in the art do have drawbacks. If the fluids are of different viscosities, there is a tendency for the low viscosity fluid to channel along the outside wall of the mixer and not be properly included in the layering process. In addition, due to the high viscosity of the materials being mixed, use of such mixers as described above can be messy and require the use of expensive solvents to clean the mixers between uses. Therefore, low cost, disposable mixers are preferred. However, if the mixers are disposed between uses, valuable material product retained within the mixer may be wasted.

Ideally, the materials to be mixed should be injected into the mixer stoichoimetrically and metered as a function of time. However, several factors may contribute to uneven proportions of injected material. For example, when using materials of differing viscosity, pulsations in the supply pump may cause uneven distribution of material entering the mixer. Also, in cases where small amounts of material are dispensed in succession, pre-flow and after-flow “drool” of the lower viscosity fluid may favor more of that component to enter the mixer, affecting the chemical diffusion of the materials and/or the homogeneous mixing of the materials.

Accordingly, it is desirable to provide a low cost, disposable mixer that allows the mixing of high viscosity liquids without the production of heat and/or turbulence associated with a mechanically driven agitator or stirrer while expending minimal energy. Similarly, there is a need for a low cost, disposable mixer that retains minimal material product after use and that is short in length, providing maximum control over the product's application. Additionally, there is a need for a mixer that provides a correcting factor to compensate for uneven distribution of material injected into the mixer.

### SUMMARY OF THE INVENTION

The foregoing needs are met, at least to a great extent, by the present invention where, in one aspect, a static mixer for mixing at least two materials includes a conduit having interior walls and a central, longitudinal axis along which the materials flow. The mixer has a number of baffles arranged inside the conduit and each baffle has two planar webs that intersect one another and extend parallel to the flow direction. In addition, the mixer has two, forward angled surfaces and two, rear angled surfaces that are connected by the two planar webs.

In another aspect, the invention provides a static mixer for mixing at least two materials that includes a conduit having interior walls and a central, longitudinal axis along which the materials flow. The mixer has a number of baffles arranged inside the conduit and each baffle has two planar webs that intersect one another and extend parallel to the flow direction wherein one web extends to form a rear fin extending in the material flow direction. In addition, the mixer has two forward angled surfaces and two rear angled surfaces that are connected by the two planar webs. Each individual baffle has a leading edge and trailing edge and a length to width ratio of 0.4 to 0.7. The length is the distance between the leading edge and the trailing edge. The width is the shortest internal diameter of the conduit taken perpendicular to the flow direction and passing through the central, longitudinal axis of the conduit.

In yet another aspect, the invention provides a static mixer for mixing at least two materials that includes a conduit having interior walls and a central, longitudinal axis along which materials flow. The mixer has a number of baffles arranged inside the conduit and each baffle has at least two planar webs that intersect one another and extend parallel to the flow direction wherein one web extends to form a rear fin extending in the material flow direction. In addition, the mixer has at least two forward angled surfaces and two rear angled surfaces that are connected by the two planar webs. The webs are positioned so they do not intersect the central, longitudinal axis of the conduit and combine with the interior walls to form two, asymmetrical, lateral passageways of varying flow area.

In still another aspect, the invention provides a method for mixing at least two materials where a stream of material is ejected into a conduit and dividing the stream into a plurality of parts using baffles having a length to width ratio of 1.0 to 1.6.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a preferred embodiment of a twenty-four stage mixer in accordance with a preferred embodiment of the invention.

FIG. 2 is an isometric view of interconnected baffles overlapping in a chain.

FIG. 3 is an isometric view of a 90° right-handed baffle employed in the mixer of FIG. 2.

FIG. 4 is an isometric view of a 90° left-handed baffle employed in the mixer of FIG. 2.

FIG. 5 is an isometric view of a 270° supplemental baffle.

FIG. 6 is a schematic representation of the progressive stages of division, expansion and recombination that may occur to the materials flowing through the mixer containing only 90° baffles.

FIG. 7 is a schematic representation of the progressive stages of division, expansion and recombination that may occur to the materials flowing through the mixer containing both 90° baffles and 270° baffles.

FIG. 8 shows a series of interconnected baffles in accordance with an embodiment of the present invention and adapted to be employed within a generally hexagonal conduit.

FIG. 9 is a cross-sectional end view of FIG. 8 showing the flow paths of the present invention, taken through line 9-9 in FIG. 8.

FIG. 10 is an isometric view of the baffle arrangement in an alternative embodiment wherein the webs of the baffles are staggered.

FIG. 11 is a side view of the embodiment of FIG. 10.

FIG. 12 is a cross-sectional end view of the embodiment of FIG. 10 showing the flow areas resulting from the staggered baffles, taken through line 12-12 in FIG. 1.

FIG. 13 shows an alternative embodiment of the present invention wherein the baffle surfaces are curved.

FIG. 14 is a side view of the embodiment of FIG. 13.

### DETAILED DESCRIPTION OF PREFERRED EMBODIMENTS OF THE INVENTION

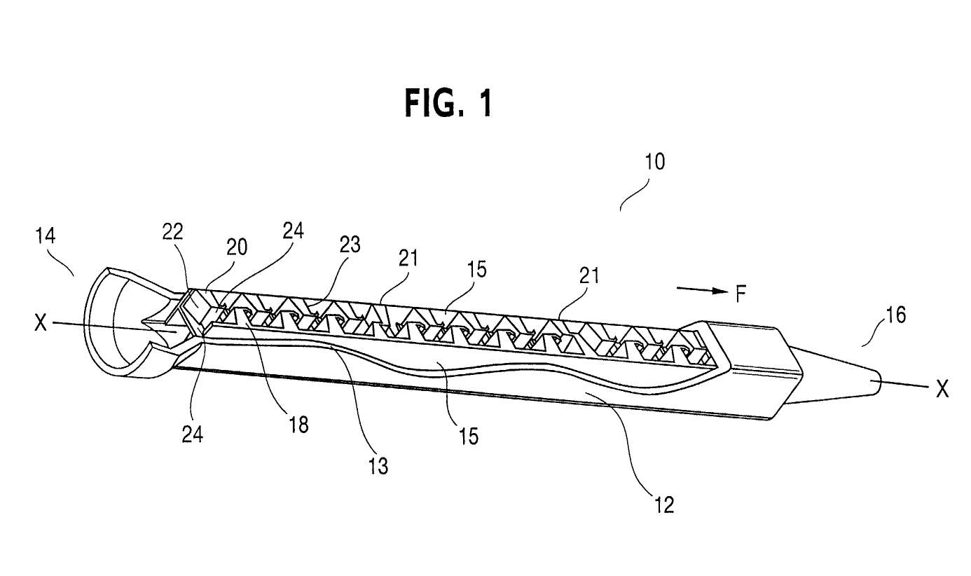

Referring now to the figures wherein like reference numerals indicate like elements, FIGS. 1-14 illustrate a presently preferred embodiment of a static mixer. While in the embodiment depicted, the mixer is used for the mixing of high viscosity liquids, it should be understood that the present invention is not limited in its application high viscosity liquids, and that it may be used to mix other suitable materials.

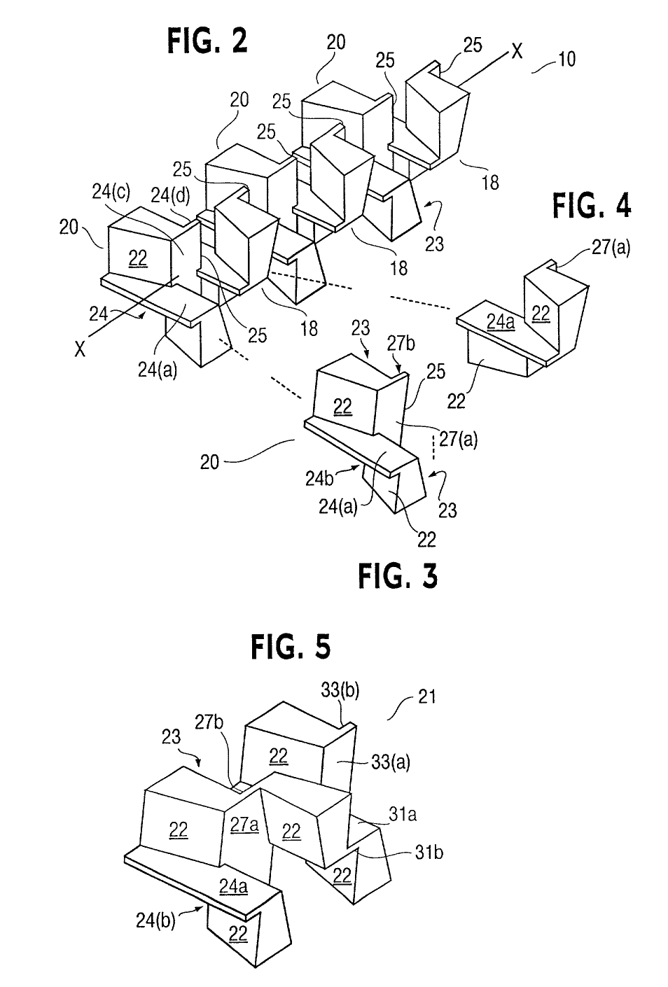

As shown in FIGS. 1-4, the static mixer 10 of the present invention comprises a conduit 12, an inlet 14, outlet 16 and a series of alternating left-handed baffles 18 and right-handed baffles 20. Two supplemental baffles 21 are also shown. FIG. 1 illustrates a twenty-four stage mixer having twenty-four baffles, indicated by the numbers 18, 20, and 21. There are eleven right-handed baffles 20, eleven left-handed baffles 20, and two supplemental baffles 21. The baffles 18, 20, 21 are positioned in the conduit 12, which has interior walls 13 and a central, longitudinal axis X along which the materials flow in a flow direction F. The baffles 18, 20 are mirror images of one another wherein one is designated as a left-handed baffle 18 and the other as a right-handed baffle 20. The baffles 18, 20 are provided with two forward, angled surfaces 22 and two rear, angled surfaces 23 (the lower surfaces are not visible in the views). The front angled surfaces 22 and rear angled surfaces 23 are connected by two planar webs 24, 27 that intersect one another. In the preferred embodiment, the baffles are formed as an integral string. The string has a pair of opposing side walls 15 (shown in FIG. 1), which slide within opposed walls 13 of the conduit and provide support and rigidity during insertion and operation. FIG. 2 illustrates a series of interconnected left-handed and right-handed baffles 18, 20 with a square cross-section that have been removed from the conduit 12 shown in FIG. 1.

FIG. 3 is a detailed view of a baffle designated as a right-handed baffle 20. The baffle 20 is provided with a first, generally planar web 24 that has opposing sides 24a and 24b and a second, 5 generally planar web 27 having opposing sides 27a and 27b. The webs 24 extend generally parallel to the flow direction and intersect one another. The baffle 20 is also provided with first, forward surface 22 wherein the surface 22 is perpendicular to one side of the web 24a and at an angle to a plane that is perpendicular to the material flow. A second, forward surface is shown in FIG. 2 wherein the surface 22 is perpendicular to the other side of the web 24b and at an angle to a plane that is perpendicular to the material flow. FIG. 2 also shows a first, rear surface 23 wherein the surface is perpendicular to one side of the web 27b and at an angle to a plane that is perpendicular to the material flow. The baffle 20 also has a second, rear surface 23. The second, rear surface is perpendicular to the other side of the 27a and at an angle to a plane that is perpendicular to the material flow. In addition, one of the webs 24, 27 extends past the rear angled surfaces 23 to form a rear fin 25 that extends in the flow direction.

FIG. 4 is a detailed view of a baffle designated as a left-handed baffle 18. The left-hand baffle 18 is formed as a mirror image of the right-hand baffle 20 shown in FIG. 3.

Embodiments of the invention can be constructed solely from right-handed and left-handed baffles. However, in some instances, the materials and/or fluid being passed through the mixer of the present invention, tend to “channel” along the peripheral walls 13 of the conduit 12 and/or side walls 15 of the string of baffles, creating the possibility for incomplete mixing. This channeling can be reduced by placing supplemental baffles 21 to enhance radial movement along the flow path. Radial movement is defined as movement of the cross-sectional exterior streams (material traveling along the periphery of the conduit) into the center of the mixer 10 and conversely, movement of the interior streams out to the peripheral walls of the conduit 12. Therefore, in the preferred embodiment, a supplemental baffle 21, as depicted in FIG. 5, is utilized to enhance radial movement along the flow path.

As shown in FIG. 5, the supplemental baffle 21 is provided with six (6) forward and rear surfaces, 22 and 23 respectively, along with four (4) planar webs 24, 27, 31, 33 that extend between the forward and rear surfaces. The first and second planar webs 24, 27, each extend parallel to the flow direction and intersect one another while the six forward surfaces and the six rear surfaces 22, 23, are all angled relative to a plane that is perpendicular to the flow direction of the mixer. The first, forward surface 22 is perpendicular to one side of the first web 24a while the second, forward surface 22 is perpendicular to the other side of the web 24b. The first, rear surface 23 is perpendicular to one side of the second web 27b while the second rear surface is perpendicular to the other side of the web 27a. The supplemental baffle 21 has a third, planar web that intersects the second planar web 24 and is similar to the first and second planar webs in that it has opposing sides and extends parallel to the flow direction. The third, forward surface 22 is perpendicular to one side of the second web 27a while the fourth, forward surface 22 (not shown) is perpendicular to the other side of the second web 27b. The fifth, forward surface 22 is perpendicular to one side of the third web 31 a while the sixth, forward surface 22 is perpendicular to the other side of the third web 31b. The fourth, planar web 33 of the supplemental baffle 21 intersects the third planar web 31 and is similar to the first, second and third planar webs in that it has opposing sides and extends parallel to the flow direction. In addition, the fourth, planar web 33 forms a rear fin 25 extending in the flow direction. The third rear surface 23 is perpendicular to the third, planar web 31 a while the fourth, rear surface is perpendicular to the other side of the third web 31b. The fifth, rear surface 23 is perpendicular one side of the fourth, planar web 33a while the sixth, rear surface is perpendicular the other side of the fourth planar web 33b. Although the angled surfaces 22, 23 are described as perpendicular to the respective webs, it will be appreciated that they are also angled relative to a plane that is perpendicular to the flow direction and accordingly they are not perpendicular to the flow direction.

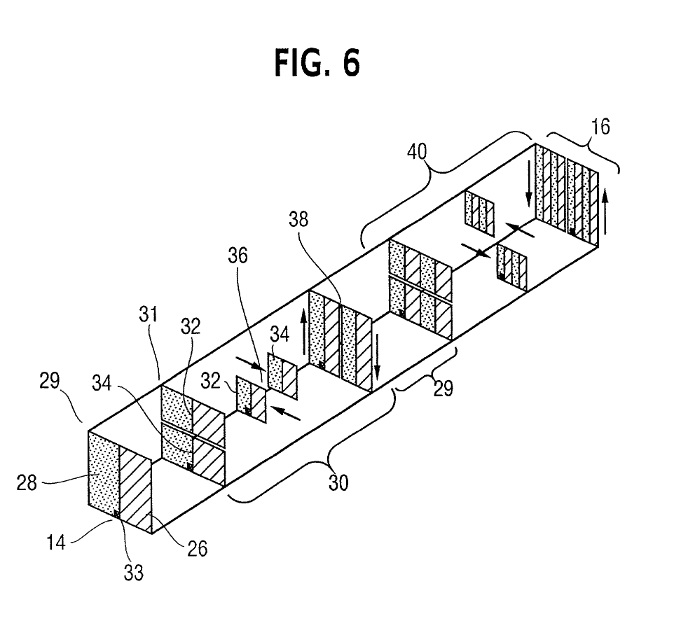

FIG. 6 illustrates the various operations that occur when a stream first passes over a right-handed 90° baffle 30 and then proceeds to pass over a left-handed 90° baffle in accordance with the present invention. In this illustration, the main stream 29 is composed two smaller streams 26, 28. Initially, the main stream 29 is divided into two sections designated by 32 and 34. In stage 36, the cross-sectional area of the streams 26, 28 is reduced without significantly rotating the flow laminae. This reduction is due to a change in flow area that occurs where the baffles are occupying a portion of the constant cross-sectional internal area of the conduit. The streams 32, 34 then proceed to stage 38 where they are widened in a direction perpendicular to the plane of division. The streams are then recombined before proceeding to the next baffle 40. As a result, a stream as shown in stage 29, after passing through a single baffle 30 in accordance with the present invention, has been transferred from two layers to four layers after passing over one baffle and transferred from four to eight after passing over the second baffle.

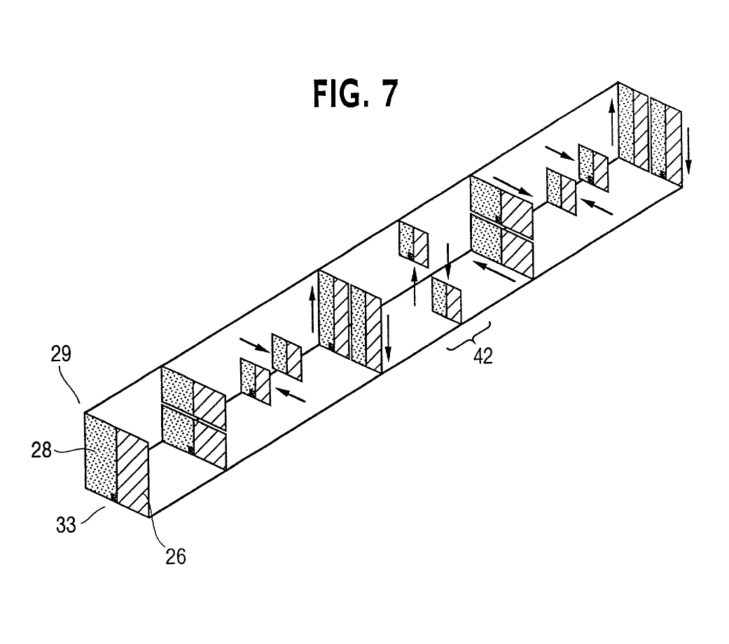

As can be observed in FIG. 6, sub-stream 28 is spot marked 33 so the flow of the sub-stream 28 may be tracked as the main stream 29 passes over two consecutive baffles 30 and 40 respectively. The mark 33 tends to stay on the bottom surface of the conduit 12, displaying the channeling phenomenon previously described. FIG. 7 illustrates the various operations that occur when a stream passes over a supplemental baffle 21 in accordance with the present invention. As illustrated in FIGS. 6 and 7, the main stream 29 is composed of two smaller streams 26, 28 wherein one of the smaller streams is spot marked 33. As it can be observed by tracking the mark 33, the streams 26, 28 have a flow path through the supplemental 21 baffle similar to the path through the 90° baffles shown in FIG. 6. However, instead of remaining on the lower surface of the conduit 12, the spot tends to work upward or towards the radial center of the mixer upon entering section 42 of the supplemental baffle 21. Thus, the supplemental baffles 21 ensure that fluids channeling along the outside walls of the conduit 12 are directed into the center of the mixer 10, thereby allowing for more appropriate layering.

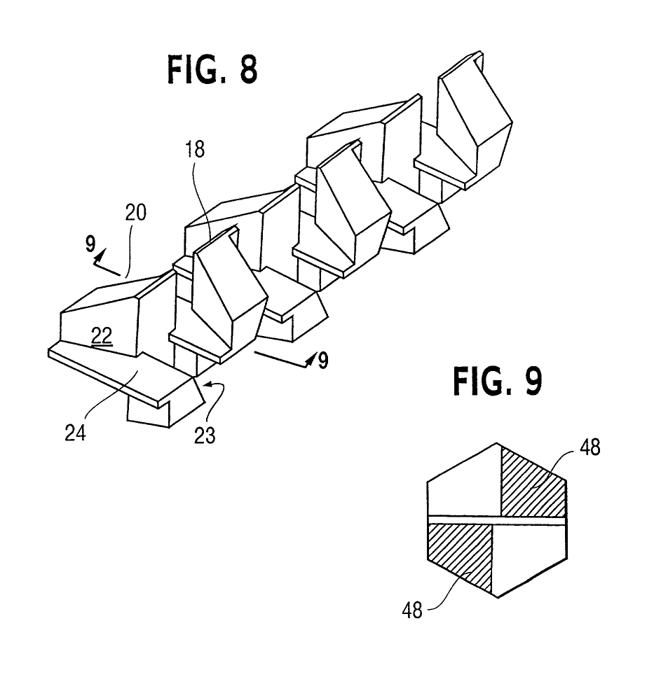

FIG. 8 is a detailed view of a series of interconnected baffles 18, 20 in accordance with an alternative embodiment of the present invention having a generally hexagonal cross-section and adapted to be used within a generally hexagonal conduit. FIG. 9 is an end view of the interconnected baffles shown in FIG. 8 showing the cross-sectional area of the flow passages 48.

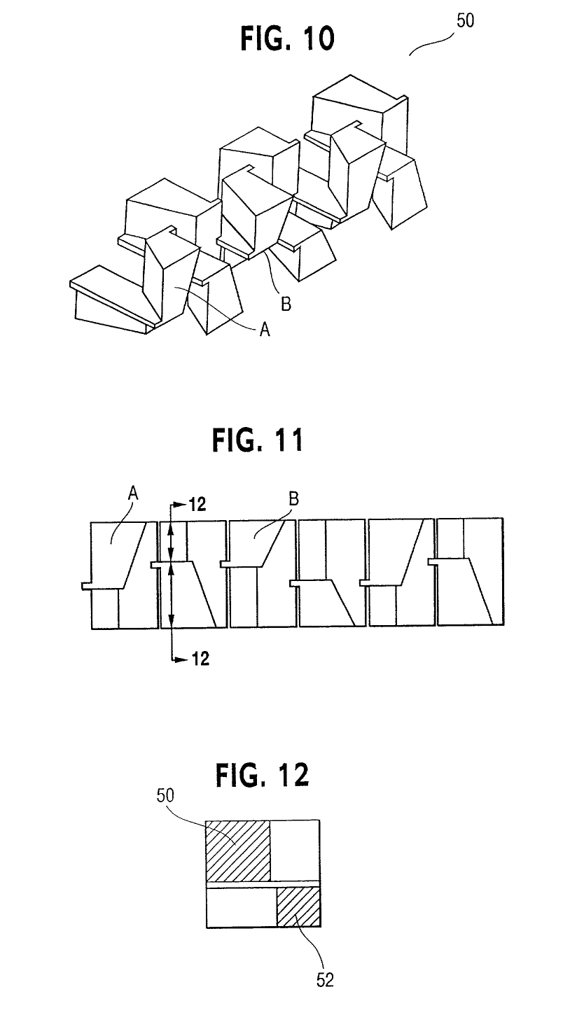

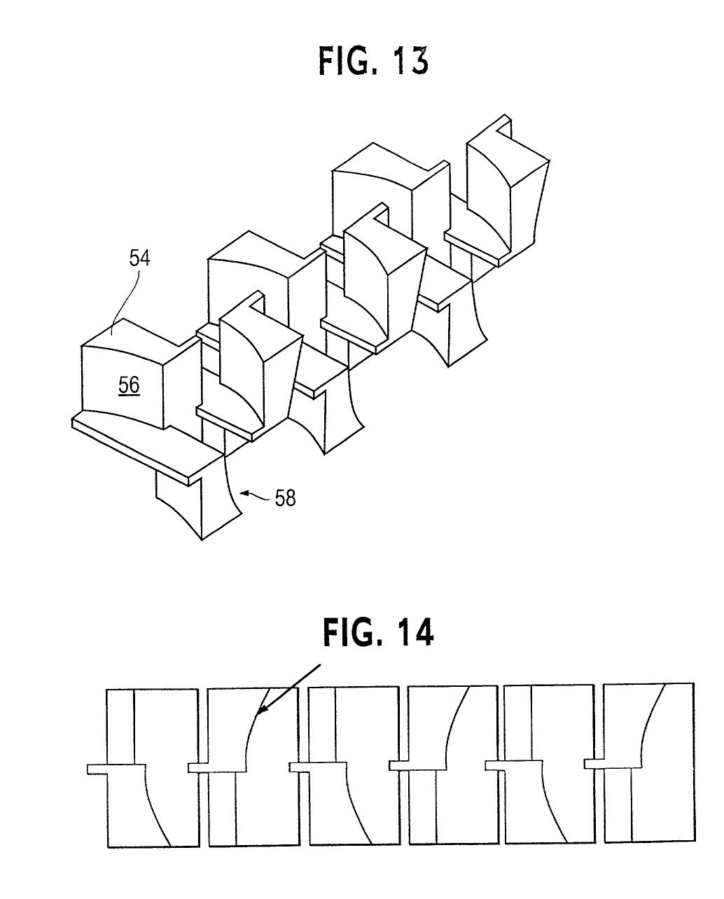

It is generally preferred, that the materials to be mixed, should be supplied to the mixer 10 in equal proportions. However, several factors contribute to the unequal proportions of materials. These factors include but are not limited to differing viscosities, pulsations of the supply pump and pre-flow and after-flow “drool” of lower viscosity material. In cases such as these, asymmetrical baffles, as depicted by A, B in FIGS. 10 and 11, may act to provide a correcting factor to the unequal distribution of materials into the mixer 10. The asymmetrical baffles result in asymmetrical flow paths 50, 52, as show in FIG. 12, wherein the flow path designated by the number 50 makes up 60% of the total flow area of the mixer and the flow path designated by 52 makes up 40% of the total flow area of the mixer. As a result of the staggered orientation of the baffles, the distribution of the flow of materials through the mixer is more even. The staggered combinations may consist of all right-handed baffles at different orientations, all left-handed baffles at different orientations, combinations of both and various similar combinations depending upon the application. It will be appreciated that in this embodiment the webs are offset from the central longitudinal axis of the mixer. In FIGS. 13 and 14 there is illustrated a series of interconnected baffles in accordance with an alternative embodiment of the present invention wherein the baffles 54 are provided with curved forward and rear surfaces, 56 and 58 respectively. The surfaces may be concave as depicted in FIGS. 13 and 14 or convex, depending upon the application.

Although the apparatus has been described as having a flow direction, this is merely for descriptive convenience. The mixer can also be operated with an opposite direction of flow.

The above description and drawings are only illustrative of preferred embodiments which achieve the objects, features, and advantages of the present invention, and is not intended that the present invention be limited thereto. Any modification of the present invention which comes within the spirit and scope of the following claims is considered to be part of the present invention.

What is claimed is:

1. A static mixer for mixing at least two materials comprising:
a conduit having interior walls and a central, longitudinal axis wherein said conduit passes the materials in a flow direction along said longitudinal axis;
a plurality of baffles arranged inside said conduit, each baffle having a first and second forward, angled surface and a first and second rear, angled surface, said forward surfaces are connected by a first generally planar web that extends parallel to the flow direction, and said rear angled surfaces are connected by a second, generally, planar web that extends parallel to the flow direction said webs intersect one another and said second web extends past said rear angled surfaces to form a fin extending in the flow direction.

2. The static mixer according to claim 1, further comprising a plurality of supplemental baffles arranged inside said conduit, each baffle having six forward angled surfaces and six rear, angled surfaces connected by four generally planar webs, wherein said webs extend generally parallel to the flow direction and intersect each other and at least one planar web extends beyond said rear, angled surfaces to form a fin extending in the material flow direction.

3. The static mixer according to claim 2, wherein said supplemental baffles provide radial movement of material flow.

4. The static mixer according to claim 2, having a total of eighteen baffles wherein at least two of the eighteen baffles are supplemental baffles.

5. The static mixer according to claim 2, having a total of twenty-four baffles wherein at least two of the twenty-four baffles are supplemental baffles.

6. The static mixer according to claim 2, having a total of thirty-six baffles wherein at least four of the thirty-six baffles are supplemental baffles.

7. The static mixer according to claim 1, wherein said angled surfaces each comprise an non-planar, curved surface.

8. The static mixer according to claim 1, further comprising a pair of opposed side walls integral with said baffles and fit within opposed interior walls of said conduit.

9. A static mixer for mixing at least two materials comprising:
a conduit having interior walls and a central, longitudinal axis wherein said conduit passes the materials in a flow direction in the direction of said longitudinal axis;
a plurality of baffles arranged inside said conduit, each baffle comprising a first, generally planar web having opposing sides and a second, generally planar web having opposing sides, wherein said webs extend generally parallel to the flow direction and intersect each other;
a first, forward surface perpendicular to one side of said first web and at an angle a plane perpendicular to the longitudinal axis;
a second, forward surface perpendicular to the other said side of said first web and at an angle to the plane perpendicular to the longitudinal axis;
a first, rear surface perpendicular to one side of said second, planar web and at an angle to the plane perpendicular to the longitudinal axis; and
a second, rear surface perpendicular to the other said side of said second web and at an angle to the plane perpendicular to the longitudinal axis, wherein at least one planar web extends past the first and second rear surfaces in the flow direction to form a rear fin.

10. The static mixer according to claim 9, further comprising a plurality of supplemental baffles arranged inside said conduit, each baffle comprising:
a first, generally planar web having opposing sides and a second generally planar web having opposing sides wherein said webs extend generally parallel to the flow direction and intersect each other;
a first, forward surface perpendicular to one side of said first web and at an angle to the plane perpendicular to the longitudinal axis;
a second, forward surface perpendicular to said other side of said first web and at an angle to the plane perpendicular to the longitudinal axis;
a first, rear surface perpendicular to one side of said second, planar web and at an angle to the plane perpendicular to the longitudinal axis;
a second, rear surface perpendicular to said other side of said second web and at an angle to the plane perpendicular to the longitudinal axis;
a third, generally planar web having opposing sides wherein said web extends generally parallel to the flow direction and intersects said second planar web;
a third, forward, surface perpendicular to one side of said second web and at an angle to the plane perpendicular to the longitudinal axis;
a fourth, forward surface perpendicular to said other side of said second web and at an angle to the plane perpendicular to the longitudinal axis;
a fifth, forward surface perpendicular to one side of said third web and at an angle to the plane perpendicular to the longitudinal axis;
a sixth, forward surface perpendicular to said other side of said third web and at an angle to the plane perpendicular to the longitudinal axis;
a fourth generally planar web having opposing sides wherein said web intersects said third planar web and extends generally parallel to the flow direction;
a third, rear surface perpendicular to one side of said third, planar web and at an angle to the plane perpendicular to the longitudinal axis;
a fourth, rear surface perpendicular to the other said side third web and at an angle to the plane perpendicular to the longitudinal axis;
a fifth, rear surface perpendicular to one side of said fourth, planar web and at an angle to the plane perpendicular to the longitudinal axis; and
a sixth, rear surface wherein said surface is perpendicular to said other side of said fourth web and at an angle to the material flow.

11. The static mixer according to claim 10, wherein said supplemental baffles provide radial movement of material flow.

12. The static mixer according to claim 10, having a total of eighteen baffles wherein at least two of the eighteen baffles are supplemental baffles.

13. The static mixer according to claim 10, having a total of twenty-four baffles wherein at least two of the twenty-four baffles are supplemental baffles.

14. The static mixer according to claim 10, having a total of thirty-six baffles wherein at least four of the thirty-six baffles are supplemental baffles.

15. The static mixer according to claim 9, wherein said forward and rear surfaces each comprise a non-planar, curved surface.

16. The static mixer according to claim 9, further comprising a pair of opposed side walls integral with said baffles and fit within opposed interior walls of said conduit.

17. A static mixer for mixing at least two materials comprising:
a conduit having interior walls and a central, longitudinal axis wherein said conduit passes the materials in a flow direction along said longitudinal axis;
a plurality of baffles arranged inside said conduit, each baffle having a first and second forward, angled surface and a first and second rear, angled surface, said forward surfaces are connected by a first generally planar web that extends parallel to the flow direction, and said rear angled surfaces are connected by a second, generally, planar web that extends parallel to the flow direction said webs intersect one another,
said baffles each having a leading edge and a trailing and a length to width ratio of 0.4 to 0.7 wherein the length is the distance between the leading edge and the trailing edge and the width is the shortest diameter of said conduit perpendicular to said flow direction and passing through said central, longitudinal axis of said conduit and defined by the shortest distance between two opposing, interior walls of said conduit.

18. The static mixer according to claim 18, further comprising a plurality of supplemental baffles arranged inside said conduit, each baffle having six forward angled surfaces and six rear, angled surfaces connected by four generally planar webs, wherein said webs extend generally parallel to the flow direction and intersect each other,
said baffles each having a leading edge and a trailing edge at an angle to one another and said baffles having a length to width ratio of 1.0 to 1.6 wherein the length is the distance between the leading edge and the trailing edge and the width is the shortest diameter of said conduit perpendicular to said flow direction and passing through said central, longitudinal axis of said conduit and defined by the shortest distance between two opposing, interior walls of said conduit.

19. The static mixer according to claim 17, wherein said angled surfaces each comprise an non-planar, curved surface.

20. The static mixer according to claim 17, further comprising a pair of opposed side walls integral with said baffles and fit within opposed interior walls of said conduit.

21. A static mixer for mixing at least two materials comprising:
a conduit having interior walls and a central, longitudinal axis wherein said conduit passes the materials in a flow direction along said longitudinal axis;
a plurality of baffles arranged inside said conduit, each baffle comprising a first, generally planar web having opposing sides and a second, generally planar web having opposing sides, wherein said webs extend generally parallel to the flow direction and intersect each other;
a first, forward surface perpendicular to one side of said first web and at an angle to the plane perpendicular to the longitudinal axis;
a second, forward surface perpendicular to the other side of said first web and at an angle to the plane perpendicular to the longitudinal axis;
a first, rear surface is perpendicular to one side of said second, planar web and at an angle to the plane perpendicular to the longitudinal axis; and
a second, rear surface perpendicular to the other side of said second web and at an angle to the plane perpendicular to the longitudinal axis; and
said baffles each having a leading edge and a trailing edge at an angle to one another and said baffles having a length to width ratio of 0.4 to 0.6 wherein the length is the distance between the leading edge and the trailing edge and the width is the shortest diameter of said conduit perpendicular to said flow direction and passing through said central, longitudinal axis of said conduit and defined by the shortest distance between two opposing, interior walls of said conduit.

22. The static mixer according to claim 21, further comprising a plurality of supplemental baffles arranged inside said conduit, each baffle comprising:
a first, generally planar web having opposing sides and a second generally planar web having opposing sides wherein said webs extend generally parallel to the flow direction and intersect each other;
a first, forward surface perpendicular to one side of said first web and at an angle to the plane perpendicular to the longitudinal axis;
a second, forward surface perpendicular to said other side of said first web and at an angle to the plane perpendicular to the longitudinal axis;
a first, rear surface perpendicular to one side of said second, planar web and at an angle to the plane perpendicular to the longitudinal axis;
a second, rear surface perpendicular to said other side of said second web and at an angle to the plane perpendicular to the longitudinal axis;
a third, generally planar web having opposing sides wherein said web extends generally parallel to the flow direction and intersects said second planar web;
a third, forward, surface perpendicular to one side of said second web and at an angle to the plane perpendicular to the longitudinal axis;
a fourth, forward surface perpendicular to said other side of said second web and at an angle to the plane perpendicular to the longitudinal axis;
a fifth, forward surface perpendicular to one side of said third web and at an angle to the plane perpendicular to the longitudinal axis;
a sixth, forward surface perpendicular to said other side of said third web and at an angle to the plane perpendicular to the longitudinal axis;
a fourth generally planar web having opposing sides wherein said web intersects said third planar web and extends generally parallel to the flow direction to form a fin extending in the flow direction;
a third, rear surface perpendicular to one side of said third, planar web and at an angle to the plane perpendicular to the longitudinal axis;
a fourth, rear surface perpendicular to said other side of said third web and at an angle to the plane perpendicular to the longitudinal axis;
a fifth, rear surface perpendicular to one side of said fourth, planar web and at an angle to the plane perpendicular to the longitudinal axis; and
a sixth, rear surface perpendicular to said other side of said fourth web and at an angle to the plane perpendicular to the longitudinal axis; and
said supplemental baffles having a leading edge and trailing edge perpendicular to one another and said baffles having a length to width ratio of 1.0 to 1.4 wherein the length is the distance between the leading edge and the trailing edge and the width is the shortest diameter of said conduit perpendicular to said flow direction and passing through said central, longitudinal axis of said conduit and defined by the shortest distance between two opposing, interior walls of said conduit.

23. The static mixer according to claim 21, wherein said forward and rear surfaces each comprise a non-planar, curved surface.

24. The static mixer according to claim 21, further comprising a pair of opposed side walls integral with said baffles and fit within opposed interior walls of said conduit.

25. A static mixer for mixing at least two materials comprising:
a conduit having interior walls and a central, longitudinal axis wherein said conduit passes the materials in a flow direction along said longitudinal axis; and
a plurality of baffles arranged in said conduit, each baffle having at least two forward surfaces and at least two rear surfaces connected by at least two planar webs, wherein said webs are arranged at varying distances from the interior walls of said conduit, wherein the interior walls and said webs combine to form two, asymmetrical, lateral passageways extending in said flow direction, each passageway having a varying flow area.

26. The static mixer according to claim 25, wherein one of said webs extends past said rear surface to form a fin extending in the flow direction.

27. A static mixer according to claim 26, further comprising a plurality of supplemental baffles arranged inside said conduit, each baffle having six forward angled surfaces and six rear, angled surfaces connected by four generally planar webs, wherein said webs extend generally parallel to the flow direction and intersect each other and at least one planar web extends beyond said rear, angled surfaces to form a fin extending in the material flow direction.

28. The static mixer according to claim 27, wherein said supplemental baffles provide radial movement of material flow.

29. The static mixer according to claim 27, having a total of eighteen baffles wherein at least two of the eighteen baffles are supplemental baffles.

30. The static mixer according to claim 27, having a total of twenty-four baffles wherein at least two of the twenty-four baffles are supplemental baffles.

31. The static mixer according to claim 27, having a total of thirty-six baffles wherein at least four of the thirty-six baffles are supplemental baffles.

32. The static mixer according to claim 25, wherein said forward and rear surfaces each comprise a non-planar, curved surface.

33. The static mixer according to claim 25, further comprising a pair of opposed side walls integral with said baffles and fit within opposed interior walls of said conduit.

34. A method for mixing at least two materials comprising the steps of:
injecting a stream of materials into said conduit;
dividing said stream into a plurality of parts by urging the stream past baffles having a length to width ratio of 0.4 to 0.7 wherein the length is the distance between a leading edge of a baffle and the trailing edge of the baffle and the width is the shortest diameter of said conduit perpendicular to said flow direction and passing through said central, longitudinal axis of said conduit and defined by the shortest distance between two opposing, interior walls of said conduit; and
recombining said parts in an overlapping relationship.

35. The method according to claim 24, further comprising the steps of:
recombining said parts with a outer portion of the original stream displaced toward the geometrical center of said stream.
